(19) United States
(12) Patent Application Publication
(10) Pub. No.: US 2001/0045392 A1
(43) Pub. Date: Nov. 29, 2001

(54) Wastewater treatment system and method

(75) Inventors: James R. Gray, Gray, ME (US); Donald R. Rousseau, Auburn, ME (US); Lloyd E. Weaver, Harpswell, ME (US)

Correspondence Address: Bourque & Associates, P.A., Suite 303, 835 Hanover Street, Manchester, NH, 03104, US

(73) Assignee: SeptiTech, Inc.

(21) Appl. No.: 09/864,648

(22) Filed: May 24, 2001

Related U.S. Application Data
(60) Provisional application No. 60/206,784, filed on May 24, 2000.

(51) Int. Cl. C02F 3/10

(52) U.S. Cl. 210/616; 210/151

(57) ABSTRACT

A wastewater treatment system is disclosed whereby trickling filters remove a high proportion of biochemical oxygen demand, total suspended solids, and nutrients from wastewater using, in one embodiment, a pressurized media container. The system accomplishes this in an improved way by combining venturies or blowers to aerate the wastewater, and recirculating the wastewater and air down through the treatment media, improving the overall efficiency of the system and reducing its size. A screen at the base of the pressurized media container supports the media and allows the wastewater to exit the pressurized media container. The system also includes a low pressure nozzle that aids in the proper distribution of the wastewater.

### CROSS-REFERENCE TO RELATED APPLICATIONS

This application is related to and claims the benefit of Provisional U.S. Patent Application No. 60/206,784 entitled Trickling Filter Pressurized Canister Wastewater Treatment, filed by the Assignee of the present invention, and incorporated herein by reference.

### TECHNICAL FIELD

The present invention relates to systems for treating wastewater, and more particularly, relates to wastewater treatment systems including biological media.

### BACKGROUND IN FORMAT ION

The object of wastewater treatment is to reduce the total suspended solids (TSS), biochemical oxygen demand (BOD), nitrogen compounds, E-coli, phosphorous, and virtually any other bacteria from the wastewater, so as to minimize the quantity of such undesirables outputted by the treatment system. Various well known means have been devised for achieving such goals, with varying degrees of success and efficiency. An overriding general problem, for the most part, with such prior systems has been the scale of operation required to effectively treat the wastewater to achieve a high-quality water output at a reasonable expense. That is, for the volumes of water to be treated, the sizes of these systems are correspondingly large. This may be particularly true for relatively small-scale systems, such as single-family residences and small groupings of homes and/or buildings, where coupling to a municipal treatment system may be unsuitable or unavailable.

The use of biological treatments to accelerate the breakdown of solids and the various contaminants associated with wastewater is also well known. The biological treatment usually involves the use of microbes having an affinity for the pollutants contained in the water. That is, rather than simply permit solids to slowly decant from the wastewater, and then apply a hazardous chemical treatment designed to destroy the pollutants, along with virtually everything else in the water, these microbes are permitted to act upon the wastewater. In relative terms, they act to remove the pollutants faster than if nothing were used, and do so without the hazardous and difficulties associated with chemical treatment.

The microbes must, however, be permitted to reside in some type of holding tank in order to multiply and feed on the contaminants. Upon completion of their ingestion of the pollutants, the microbes simply die and are removed. The treated water then passes to the next stage, which may simply be some form of a leach bed, or it may be a more complex system, including, but not limited to, an ultraviolet disinfection means for subsequent transport to a body of water, or for recycling in non-critical uses, such as horticulture.

Unfortunately, while biological treatment has significant advantages, use of the microbes requires a sufficient “dwell time” for the microbes to “eat” enough of the pollutants so that the wastewater is rendered satisfactorily contaminant-free. Of course, the extent to which contaminant removal is satisfactory is a function of governmental regulation. In any case, the volume of water that must be treated can often lead to the need for a rather large-scale treatment unit for a relatively small waste-water-generating facility. This is particularly true for small scale (i.e., single or small groups of individual housing) were any economies of scale are impossible. As a result, wastewater treatment is particularly expensive for individuals. Furthermore, treatment for larger groups can be expensive as well due to the even larger scale necessary to meet the government requirements.

Another problem associated with many of the prior systems results from “plugging” of the system. The plugging can result from either the solids entrapped in the effluent stream or from biological build-up. As the microbes live and die, their mass can build up and reduce the efficiency of the system by blocking the access of the living microbes to the pollutants or by simply plugging the system altogether.

A further problem associated with many of the prior systems is their inability to effectively oxygenate the wastewater. Without the necessary oxygen, many of the microbes will not be able to sustain life. The ability of a system to introduce oxygen is a factor in overall size of the system, i.e. the amount of oxygen per square foot is proportionate to the amount of microbes in the system per square foot.

Several prior wastewater treatment systems have been described. These systems have apparently been designed for large- and/or small-scale treatment using biological media to accelerate contaminant reduction. For the most part, they include biological treatment as well as mechanisms designed to enhance the effectiveness of the microbial action. However, each in turn suffers from one or more deficiencies that significantly affect the ability to provide the most effective and relatively inexpensive waste treatment system.

Therefore, what is needed is a media containment apparatus and that takes advantage of the useful characteristics of biological treatment in an effective manner. What is also needed is such an apparatus and process that maximizes the contact between contaminants from the wastewater and the microbes without the need for a relatively large processing tank or unit. Further, what is needed is an apparatus and process that operates economically and without the need to periodic maintenance.

### SUMMARY

According to one embodiment of the present invention, there is provided a wastewater treatment system including at least one recirculation tank for containment of wastewater to be treated, and at least one low pressure helical spray nozzle. Optionally, the wastewater treatment system may include at least one pressurized media canisters in fluid communication with the recirculation tank and containing the treatment media.

In another embodiment, a wastewater treatment system includes at least one recirculation tank, at least one wastewater treatment region, and at least one venturi. The treatment region may contain a treatment medium in fluid communication with the recirculation tank for treating the wastewater. The venturi inputs at least 2000 cubic feet of air per pound of biochemical oxygen demand into the wastewater to be treated. Optionally, the system may include at least one low pressure nozzle.

In yet another embodiment, the wastewater treatment system comprises a recirculation tank for containment of the wastewater, at least one treatment region, and a recirculation system for circulating the wastewater from the recirculation tank to the treatment region. The recirculation system comprises piping means for fluidly connecting the recirculation tank to the treatment region, at least one pump, at least one venturi for inputting air into the wastewater, and at least one low pressure helical nozzle for dispersing the wastewater within the treatment region.

In any one of the above embodiments, the treatment medium may comprise a fixed bed of hydrophobic particles sized to create interstices therebetween and surface area sufficient for microbes to grow and for dead microbes and treated waste water to pass therethrough.

### BRIEF DESCRIPTION OF THE DRAWINGS

These and other features and advantages of the present invention will be better understood by reading the following detailed description, taken together with the drawings wherein:

FIG. 1 is a cross sectional view of an embodiment of the present invention;

FIG. 2 is a schematic flow diagram of an embodiment of the present invention;

FIG. 3 is a cross sectional view of one embodiment of the pressurized canister of the present invention;

FIG. 4 is an expanded view the media according to one embodiment of the present invention; and

FIG. 5 is a side plain view of the low-pressure spiral nozzle according to one embodiment of the present invention.

### DETAILED DESCRIPTION OF THE PREFERRED EMBODIMENTS

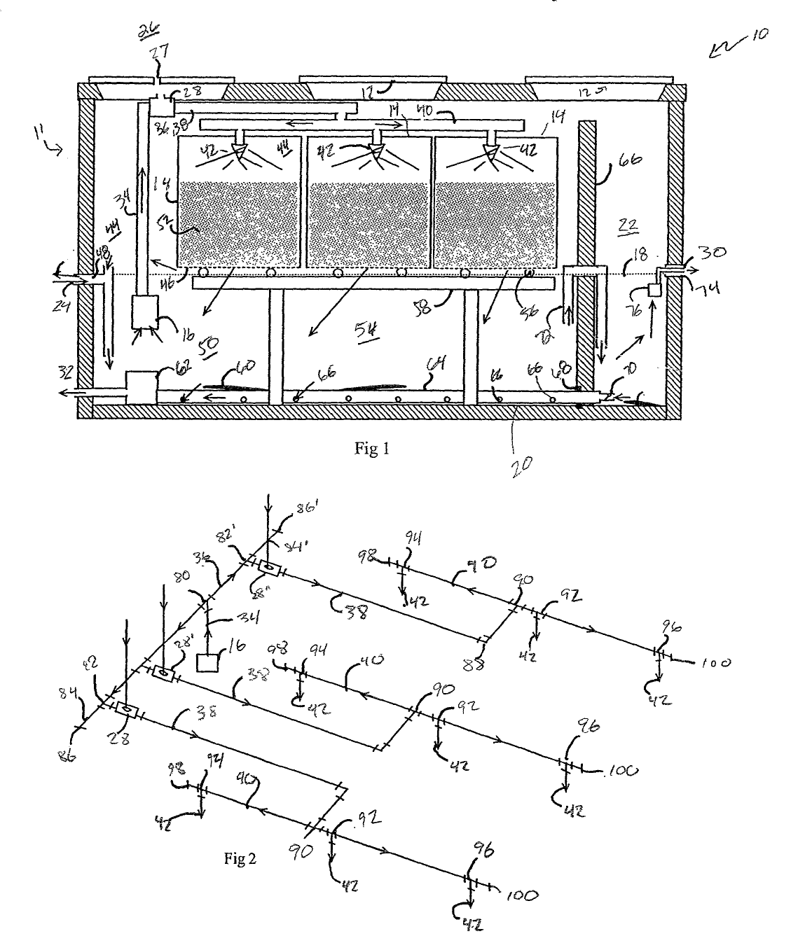

One embodiment of the wastewater treatment system 10, FIG. 1, according to the present invention, is generally housed in a concrete or plastic recirculation tank 11, though other materials such as metal are also envisioned. At least one cover 12 allows access to the system 10. The size of the system 10, including at least one pressurized media container 14, is determined by the amount of wastewater to be treated and is well within the knowledge of one of ordinary skill in the art.

In a preferred embodiment, a twenty-four inch diameter pressurized media container 14 can treat about 150 gallons per day. The recirculation tank 11 and associated number of pressurized media containers 14 and recirculation pump 16 are proportioned larger or smaller to treat various quantities of water. For example, recirculation spray pump 16, sized to achieve a maximum of 2 gpm/sqft of media area is located approximately ⅓ down between the water level 18 and the 20 floor of tank 11. This pump 16 is preferably a submerged sump type pump generally of the kind used to pump diluted effluent.

A decant zone 22 preferably has a projected top surface area sized generally at a minimum of about one square foot per 500 gallons of wastewater treated per day. The projected top surface area is sized to allow for sufficient time of any residual solids to settle. In a preferred embodiment, the system 10 has at least the following inputs/outputs: input wastewater 24, input air 26, treated water discharge 30, and sludge reject 32.

Effluent flows into tank 11 via gravity or a pump from a septic tank (not shown) or other containment vessel that substantially filters out the larger solids. Pump 16 then delivers a large quantity of water efficiently, but at low pressures to the pressurized media container 14. A simple cycle timer relay (not shown) with individually adjusted on and off cycles operates pump 16. The pump 16 would see at least 50% duty cycle and the shortest on-time limited to about ten minutes. More on-time as opposed to off-time will enable more water to be treated or less water treated to a higher degree.

Three pressurized media containers 14 are shown, but more or less can be utilized depending upon the amount of input wastewater 24 to be treated. Also, the pressurized media containers 14 are shown within the tank 11, but may also be contained outside of the tank 11. The pressurized media containers 14 are preferably pressurized with air 26 introduced by the venturies 28 brought in through tank openings 27. Air 26 is distributed from the venturies 28 through a pipe header system, not shown. In an alternative embodiment, the pressurized media containers 14 can be pressurized using a blower (not shown) or any other means of increasing air pressure. The pressurized media containers 14 require about 2000 cubic feet of air per pound of BOD treated from the venturies 28 or blower.

Excess air 44 not absorbed by the treatment process exits the canister 14 through media support screen 46 and exits the tank 11 preferably through the input 24 void space 48 enabling excess air 44 to pass through the septic tank (not shown) and up through the house's vent stack or stink pipe (not shown). Recirculated water 50 trickles down through the media 52 held within the pressurized media containers 14 and out screens 46 to the recirculated water volume 54, which is constantly being drawn back to pump 16.

In a preferred embodiment, the pressurized media containers 14 are supported by 2-inch diameter PVC joists 56 spaced two per canister. Joists 56 are supported by at least two equally spaced 3-inch diameter PVC pipe beams 58 ninety degrees apposed from joists 56. Other support structures are envisioned, and the system is not limited in any way to the above described support structure.

Solids 60 generally settle under pump 16, but some may travel into the decant zone 22 and settle out there. These solids 60 are removed periodically by pump 62 preferably located near the input floor area of the tank 11, and the solids 60 are rejected back to the septic tank (not shown). Control of pump 62 is preferably by a simple cycle timer relay (not shown) with individually adjusted on and off cycles set to limit the flow of this pump 62 to a maximum of one tenth of the input flow daily with pump on-time dependent on the size of the pump and its installed head losses. Other systems for controlling the pump are envisioned including such as height control devices, weight control devices, etc.

A pipe 64 connected to sump pump 62 traverses along the base of tank 11 and through tank partition 66 that creates a decant zone 22. In another embodiment, the decant zone 22 is separate from the tank 11. Pipe 64 preferably has holes 66 drilled about every foot along its length. This pipe 64 may also pass through the water-proof wall partition 66 into the decant zone 22 through a water-proof bulkhead ring 68 and preferably has a flapper check valve 70 to prevent water from short circuiting through holes 66 into the bottom of the decant zone 22. Treated water preferably flows through a gravity inverted siphon 72 from the recirculation water volume 54 to the decant zone 22. This water 50 can be discharged through opening 74 by gravity or under pressure by pump 76.

FIG. 2 is an isometric plumbing arrangement of one embodiment of the present invention although a specific embodiment is described, the exact arrangement and specific elements utilized are purely for illustrative purposes only. A multitude of modifications are envisioned, and are well within the ordinary skill of the plumbing arts. In order for multiple media canisters 14 to operate properly from a single pump 16 and three venturies 28, it is preferable to introduce a certain amount of randomness, chaos, or turbulences into the flow header design by using tee's at the ends instead of smooth elbows in the heeders. This minimizes pressure differences feeding the venturies resulting in nearly identical performance between venturies.

Pump 16 pressurizes riser 34 through tee 80 located mid way to the first two venturies 28 on venturi feed header 36. As noted above, uniform water distribution is accomplished for each venturi 28 by chaos caused by tees 82 and 82′ on each end, and with extension pipes 84 and 84′ respectively inducing additional chaos. Caps 86 and 86′ seal each end of the venturies' feed header 36. Branch headers 38 that follow the venturies 28 feed mid way to the final distribution headers 40 through elbows 88 and tees 90. The extension pipes 38 create more chaos between induced air and the water and enhance venturi 28 operation by pulling in more air per unit volume of water than otherwise would occur before making a right angle turn to feed the air and water mix to final distribution headers 40. This is also aided by introducing the flow into the headers 40 near the center through tees 90.

Headers 40 are can be comprised of vertical distribution tee's 92 center, and tee's 94 and 96 and caps 98 and 100 respectively at the ends of distribution pipes 40. It is preferred, though not required, that tee's 94 and 96 are not ninety-degree elbows. The use of tee's 94 and 96 at the ends of header pipes 40 add additional chaos to evenly distribute the flow to the respective media canisters 14. It should be stressed that the above description is only one embodiment of the present invention. The exact layout of the system 1 will depend on a multitude of variables such as, but not limited to, the amount of BOD to be treated, the location parameters, etc. These variable are common to all wastewater treatment systems, and modifications to the above described embodiment are well within the ordinary skill of one in the art.

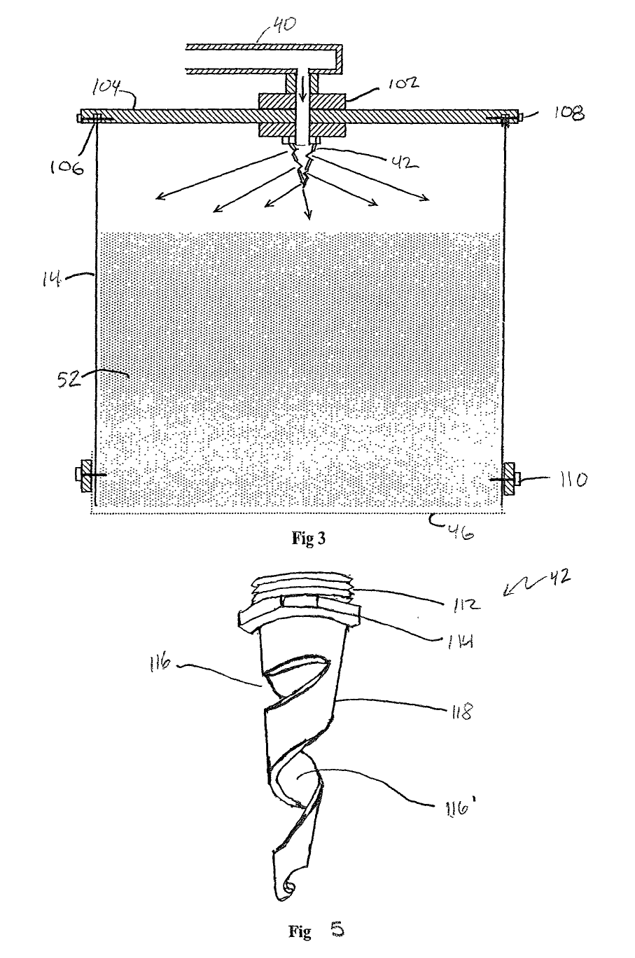

FIG. 3 is a cross sectional view of one embodiment of the pressurized media canister 14 containing media 52. In a preferred embodiment, the pressurized media canister 14 contains at least one low-pressure nozzle 42 and contains media 52 preferably having a depth of about twenty-four inches and an overall height of about thirty-six inches. Wastewater is preferably fed down into the pressurized media container 14 through an airtight threaded bulkhead fitting 102.

In a preferred embodiment, an airtight cap 104 is preferably about one half inch thick polyethylene. The airtight cap 104 retains the excess air 26 forcing it down through the media 52, along with the wastewater. The pressurized media canister 14 is preferably maintained airtight with slot 106 filled with silicon. Caps 104 are retained to the pressurized media canister 14 preferably using #8 stainless self-tapping screws 108. Testing has shown that only enough screws 108 are required to retain a pressure of about one inch of water pressure, or about twenty pounds of force up against a twenty-four inch inside diameter for caps 104.

The high surface area media 52, about one hundred eighty square feet per cubic foot, retains the microbial biomass that lives within the media. Media 52 is preferably hydrophobic so it won't plug, yet it should be light and inexpensive so that canisters 14 supports 58 do not have to be excessive. The preferred media 52 is “A” type polystyrene beads, but other media 52 such as, but not limited to, polyethylene, polypropylene, ABS, or any molded plastic can also be used.

To live and reproduce more rapidly, microbes need oxygen. Pressurizing the media containers 14 increases the time for the air 26 to be absorbed by the wastewater as it slowly passes through the media 52. It takes far longer, for example, for air to pass down through the media than it does water, over a hundred times longer.

Thus, pressurization of air 26 over the media 52 greatly improves the efficiency of air utilization. Screens 46 are preferably attached to the bottom of the pressurized containers 14 are preferably an extruded polyethylene screen with openings smaller than the “A” sized bead media 52 an allow dead microbes to trickle out with the water. Screen 46 is preferably wrapped up around the bottom outside of canisters 14, and retained with a one inch wide by one eighth inch thick polyethylene band that is secured with #8 stainless self-tapping screws 110.

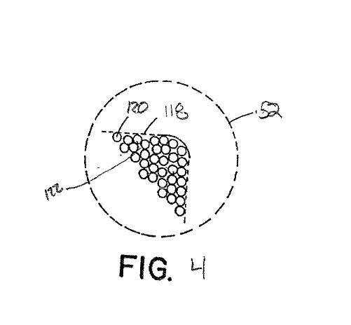

In one embodiment, the media 52, FIG. 4, is preferably a set of small-sized spheres or beads 120 that may be hollow, but that are preferably solid. The beads 120 are much smaller than buoyant balls yet large enough to create interstices 122 through which the wastewater, as well as air 26 for the aerobic process, can pass. The interstices 122 create significant surface area in a relatively small unit, surface area upon which the microbes can reside for interaction with the passing wastewater. Further, the interstices 122 provided by the bead 120 arrangement of the present invention are big enough to allow dead microbes to pass therethrough upon completion of their task. The net result is a continual sloughing off of dead microbes that have ingested more than their weight in contaminants. The quantity and size of the interstices 122 created greatly increases the effective space for biological action to occur without the need for a very large treatment tank or unit. The beads 120 are preferably substantially hydrophobic so that they are not detrimentally altered—whether by swelling or deterioration—by substantially continuous contact with wastewater. Of course, it is necessary that there is some surface roughness or other means for retaining microbes on suitable dwelling sites on the beads 120 surfaces. It has been determined that non-metallic materials, such as plastic beads, and polystyrene beads in particular, are suitable for use in the present invention. The media 52 may also be contained in mesh bags 118 as described in U.S. Pat. No. 6,187,183 assigned to the assignees of the present application, and incorporated fully herein be reference.

Through the use of the bead medium 120, the pressurized media containers 14 of the present invention used to hold the porous medium, can be relatively small in relation to the quantity of wastewater to be treated. Moreover, it can be larger in its horizontal dimension than its vertical, such that it can be unobtrusively low to the ground. For the most part, prior devices were made of relatively great height so that waste water had to move a considerable downward distance to reach the output point. That was the way in which dwell time could be increased. Of course, it also increased the space and cost associated with such systems. The creation of pressurized media container 14 eliminates the need for large, deep treatment units, especially when combined with the above-described media 52.

In another embodiment, the pressurized media container 14 may also have one or more low-pressure spray nozzles 42. It is important to achieve even water distribution over the area of the media 52 in order to ensure maximum efficiency. The low-pressure spray nozzles 42 should preferably work with only about fifty inches of water pressure or about two psi, and must accommodate both high water flow and air simultaneously. For a typical twenty-four inch diameter pressurized media container 14, this is accomplished by opening up the low-pressure spray nozzle 42 to accommodate a one-inch pipe diameter for both wastewater and air 26 feed to each pressurized media container 14. Larger pressurized media containers 14 would require proportionally larger low-pressure spray nozzles 42.

In one embodiment, the low-pressure spray nozzles 42, FIG. 5, are helical and have a one-inch male pipe thread 112 and hex nut 114. The helical low-pressure spray nozzles 42 preferably have at least two rotations of the open helix with three-eighths inch wide openings 116 and 116′ for wastewater to pass, and a tapered body 118 of about one eighth inch thickness minimum. The overall body length is about three inches. In operation, the helix fills with the air and wastewater mixture and sprays most of the air wastewater mixture from the top or first helical opening 116, which reaches out to the furthest diameter. It sprays proportionally less water from the lower helical opening 116′ spraying to a lesser diameter than the first helix. The helical low-pressure spray nozzles can be used with the wastewater treatment system described above, or with any other type such as, but not limited to, systems utilizing activated carbon, ultraviolet disinfection, or any other biological filtration such as the wastewater treatment system described in U.S. Pat. No. 6,187,183, issued to the assignee of the present invention, and fully incorporate herein by reference.

Modifications and substitutions by one of ordinary skill in the art are considered to be within the scope of the present invention, which is not to be limited except by the following claims.

The invention claimed is:

1. A wastewater treatment system comprising:
at least one recirculation tank for containment of wastewater to be treated;
at least one treatment region; and
at least one low pressure helical nozzle capable of operating at pressures of about 2 pounds per square inch, wherein said low pressure helical nozzle evenly distributes said wastewater in said treatment region.

2. The wastewater treatment system as claimed in claim 1 wherein said treatment medium comprises a fixed bed of hydrophobic particles sized to create interstices therebetween and surface area sufficient for microbes to grow and for dead microbes and treated wastewater to pass therethrough.

3. The wastewater treatment system of claim 2 wherein said treatment region is a pressurized media container.

4. The wastewater treatment system of claim 1 further comprising a means for introducing air into said pressurized media canister.

5. The wastewater treatment system of claim 4 wherein said means for introducing air into said pressurized media canister comprises at least one venturi.

6. The wastewater treatment system of claim 4 wherein said means for introducing air into said pressurized media canister comprises at least one blower.

7. The wastewater treatment system of claim 4 further comprising at least one low pressure nozzle for evenly distributing said wastewater throughout said at least one pressurized canister.

8. A wastewater treatment system comprising:
at least one wastewater treatment region for receiving a wastewater stream to be treated; and
at least one venturi for inputting air into said wastewater stream.

9. The wastewater treatment system of claim 8 wherein said at least one venturi inputs at least 2000 cubic feet of air per pound of biochemical oxygen demand into said wastewater to be treated.

10. The wastewater treatment system of claim 8 wherein said wastewater treatment region comprises:
at least one recirculation tank for the containment of said wastewater; and
a fixed bed of hydrophobic particles sized to create interstices therebetween and surface area sufficient for microbes to grow and for dead microbes and treated wastewater to pass therethrough.

11. The wastewater treatment system of claim 8 wherein said wastewater treatment region comprises:
at least one recirculation tank for the containment of said wastewater; and
at least one pressurized media canister for treating said wastewater, said pressurized canister in fluid communication with said recirculation tank and containing a treatment medium.

12. The wastewater treatment system of claim 11 further comprising at least one low pressure nozzle for evenly distributing said wastewater throughout said at least one pressurized canister.

13. The wastewater treatment system of claim 12 wherein said low pressure nozzle is a helical nozzle capable of operating at pressures of about 2 pounds per square inch.

14. The wastewater treatment system of claim 13 wherein said system includes at least three pressurized canisters and at least three low pressure helical nozzles.

15. A wastewater treatment system comprising:
a recirculation tank for containment of said wastewater;
at least one treatment region; and
a recirculation system for circulating said wastewater from said recirculation tank to said treatment region, said recirculation system comprising:
piping means for fluidly connecting said recirculation tank to said treatment region;
at least one pump;
at least one venturi for inputting air into said wastewater; and
at least one low pressure helical nozzle for dispersing said wastewater within said treatment region.

16. The wastewater treatment system of claim 15 wherein said treatment region comprises at least one pressurized canister containing a treatment medium for the treatment of said wastewater;

17. The wastewater treatment system of claim 16, wherein said treatment medium comprises a fixed bed of hy drophobic particles sized to create interstices therebetween and surface area sufficient for microbes to grow and for dead microbes and treated waste water to pass therethrough.

18. The wastewater treatment system of claim 17, wherein said hydrophobic particles are selected from the group consisting of polyethylene, polystyrene, polypropylene, ABS, any molded plastic. made of plastic material.

19. The wastewater treatment system of claim 17, wherein said hydrophobic particles comprise beads.

20. The wastewater treatment system of claim 16 wherein said venturi inputs at least 2000 cubic feet of air per pound of biochemical oxygen demand into said wastewater to be treated.

21. The wastewater treatment system of claim 16 wherein said low pressure nozzle is a helical nozzle capable of operating at pressures of about 2 pounds per square inch.

22. A wastewater treatment system comprising:
a recirculation tank for containment of said wastewater;
at least one treatment region; and
a recirculation system for circulating said wastewater from said recirculation tank to said treatment region, said recirculation system comprising:
piping means for fluidly connecting said recirculation tank to said treatment region;
at least one pump; and
at least one low pressure helical nozzle for dispersing said wastewater within said treatment region.

23. A wastewater treatment system comprising:
a recirculation tank for containment of said wastewater;
at least one treatment region; and
a recirculation system for circulating said wastewater from said recirculation tank to said treatment region, said recirculation system comprising:
piping means for fluidly connecting said recirculation tank to said treatment region;
at least one pump; and
at least one venturi for inputting air into said wastewater.

24. A wastewater treatment system comprising:
at least one recirculation tank for containment of wastewater to be treated;
at least one treatment region including a bed of hydrophobic particles sized to create interstices therebetween and having a surface area sufficient for microbes to grow and for dead microbes and treated wastewater to pass therethrough; and
at least one low pressure helical nozzle capable of operating at pressures of about 2 pounds per square inch, wherein said low pressure helical nozzle evenly distributes said wastewater in said treatment region.

25. A wastewater treatment system comprising:
at least one recirculation tank for containment of wastewater to be treated; and
at least one pressurized media canister for treating said wastewater, said pressurized canister in fluid communication with said recirculation tank and containing a treatment medium.

26. The wastewater treatment system as claimed in claim 25 wherein said treatment medium comprises a fixed bed of hydrophobic particles sized to create interstices therebetween and surface area sufficient for microbes to grow and for dead microbes and treated waste water to pass therethrough.

27. The wastewater treatment system of claim 26, wherein said hydrophobic particles are made of plastic material.

28. The wastewater treatment system of claim 26, wherein said hydrophobic particles are made of molded plastic media.

29. The wastewater treatment system of claim 28, wherein said molded plastic media is selected from the group consisting of polyethylene, polystyrene, polypropylene, and ABS.

30. The wastewater treatment system of claim 26, wherein said hydrophobic particles comprise beads.

31. The wastewater treatment system of claim 25 wherein said at least one pressurized canister further comprises a screen located on the bottom of said pressurized canister for said wastewater to exit.

32. The wastewater treatment system of claim 25 further comprising a means for introducing air into said pressurized media canister.

33. The wastewater treatment system of claim 32 wherein said means for introducing air into said pressurized media canister comprises at least one venturi.

34. The wastewater treatment system of claim 32 wherein said means for compressing air into said pressurized media canister comprises at least one blower.

35. The wastewater treatment system of claim 32 further comprising at least one low pressure nozzle for evenly distributing said wastewater throughout said at least one pressurized canister.

36. The wastewater treatment system of claim 35 wherein said low pressure nozzle is a helical nozzle capable of operating at pressures of about 2 pounds per square inch.

37. A wastewater treatment system comprising:
at least one recirculation tank, for containment of wastewater to be treated;
at least one pressurized media canister, for treating said wastewater, said pressurized canister in fluid communication with said recirculation tank and containing a treatment medium; and
at least one venturi, for inputting at least 2000 cubic feet of air per pound of biochemical oxygen demand into said wastewater to be treated.

38. The wastewater treatment system of claim 37 further comprising at least one low pressure nozzle, for evenly distributing said wastewater generally throughout said at least one pressurized canister.

39. The wastewater treatment system of claim 38 wherein said low pressure nozzle is a helical nozzle capable of operating at pressures of about 2 pounds per square inch.

40. The wastewater treatment system of claim 39 wherein said system includes at least three pressurized canisters and at least three low pressure helical nozzles.

41. The wastewater treatment system of claim 40 wherein said wastewater treatment system is a uniform structure.

42. The wastewater treatment system comprising:
a recirculation tank, for containment of said wastewater;
at least one pressurized canister containing a treatment medium for the treatment of said wastewater; and
a recirculation system, for circulating said wastewater from said recirculation tank to said pressurized canister, said recirculation system comprising:
piping means for fluidly connecting said recirculation tank to said pressurized canister;
at least one pump;
at least one venturi for inputting air into said wastewater; and
at least one low pressure nozzle, for dispersing said wastewater within said pressurized canister.

43. The wastewater treatment system of claim 42, wherein said treatment medium comprises a fixed bed of hydrophobic particles sized to create interstices therebetween and surface area sufficient for microbes to grow and for dead microbes and treated waste water to pass therethrough.

44. The wastewater treatment system of claim 43, wherein said hydrophobic particles are made of molded plastic media.

45. The wastewater treatment system of claim 44, wherein said molded plastic media is selected from the group consisting of polyethylene, polystyrene, polypropylene, and ABS.

46. The wastewater treatment system of claim 45, wherein said hydrophobic particles comprise beads.

47. The wastewater treatment system of claim 44 wherein said venturi inputs at least 2000 cubic feet of air per pound of biochemical oxygen demand into said wastewater.

48. The wastewater treatment system of claim 44 wherein said low pressure nozzle is a located above said treatment medium.

49. The wastewater treatment system of claim 48 wherein said low pressure nozzle is a helical nozzle capable of operating at pressures of about 2 pounds per square inch.

50. A wastewater treatment system comprising:
a recirculation tank, for containment of said wastewater; at least one pressurized canister containing a treatment medium for the treatment of said wastewater; and
a recirculation system, for circulating said wastewater from said recirculation tank to said pressurized canister, said recirculation system comprising:
piping means for fluidly connecting said recirculation tank to said pressurized canister;
at least one pump; and
at least one venturi for inputting air into said wastewater.

51. A wastewater treatment system comprising:
a recirculation tank, for containment of said wastewater;
at least one pressurized canister containing a treatment medium for the treatment of said wastewater; and
a recirculation system, for circulating said wastewater from said recirculation tank to said pressurized canister, said recirculation system comprising:
piping means for fluidly connecting said recirculation tank to said pressurized canister;
at least one pump; and
at least one low pressure nozzle, for dispersing said wastewater within said pressurized canister.

52. A wastewater treatment system comprising:
at least one recirculation tank for containment of wastewater to be treated; and
at least one pressurized media canister for treating said wastewater, said pressurized canister in fluid communication with said recirculation tank and containing a treatment medium, said treatment medium comprising a fixed bed of hydrophobic particles sized to create interstices therebetween and surface area sufficient for microbes to grow and for dead microbes and treated waste water to pass therethrough.
